(19) United States
(12) Patent Application Publication
(10) Pub. No.: US 2012/0208042 A1
(43) Pub. Date: Aug. 16, 2012

(54) STAINLESS STEEL ARTICLE AND METHOD FOR MAKING SAME

(75) Inventors: WU-ZHENG OU, Shindian (TW); PO-FENG HO, Shindian (TW); XIN-WU GUAN, Shenzhen City (CN); TIAN-FENG HUANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/216,733

(22) Filed: Aug. 24, 2011

(30) Foreign Application Priority Data
Feb. 14, 2011 (CN) 201110037565.3

(51) Int. Cl. B32B 3/30; C25F 3/16; B23K 26/38

(52) U.S. Cl. 428/600; 219/121.69; 205/661

(57) ABSTRACT

A stainless steel article is provided. The stainless steel article includes a stainless steel substrate, and a pattern formed on an outer surface of the substrate. The pattern is defined by at least one recess formed on the outer surface. The pattern has a surface roughness of about 50 nm-150 nm. A method for making the present article is also provided.

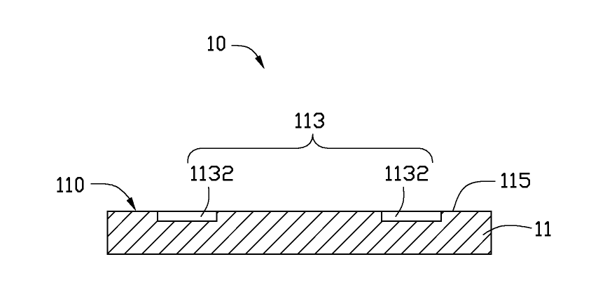

### BACKGROUND

1. Technical field

The present disclosure generally relates to a stainless steel article and a method for making the article.

2. Description of related art

Stainless steel device housings often have logos and patterns formed on them. One method for forming a logo on stainless steel housings includes laser etching or chemical etching portion of the surface. However, logos formed by such method usually have a dull appearance.

Therefore, there is room for improvement within the art.

### BRIEF DESCRIPTION OF THE DRAWING

Many aspects of the stainless steel article and method for making the article can be better understood with reference to the following drawing. The components in the drawing are not necessarily to scale, the emphasis instead being placed upon clearly illustrating the principles of the present stainless steel article and method for making the article.

The figure is a cross-sectional view of an exemplary embodiment of the present stainless steel article.

### DETAILED DESCRIPTION

The figure shows an exemplary embodiment of a stainless steel article 10. In this exemplary embodiment, the stainless steel article 10 may be a housing for an electronic device such as a mobile phone. The stainless steel article 10 includes a stainless steel substrate 11. The substrate 11 has pattern 113 and non-pattern areas 115 formed on its outer surface 110 (surface facing the environment).

The pattern 113 is defined by at least one recess 1132 formed on the outer surface 110. The at least one recess 1132 may result from a laser etching process or a chemical etching process followed an electrolyte-plasma polishing process applied to the substrate 11. The pattern 113 has a surface roughness of about 50 nm-150 nm, presenting a high glossy appearance. The depth of the at least one recess may be about 0.08 mm-0.10 mm.

The non-pattern areas 115 are portions of the outer surface 110 besides the pattern 113. The non-pattern areas 115 may have a sandblasted surface or a hairline finished surface, presenting a relatively lackluster appearance.

The pattern 113 has a glossy appearance and can be three-dimensional patterns, characters, or logos. The pattern 113 together with the non-pattern area 115 can achieve a composite appearance.

An exemplary method for making the stainless steel article 10 may include the following steps.

The substrate 11 having the outer surface 110 is provided. The substrate 11 may be degreased.

The pattern 113 is formed on the outer surface 110 by a laser etching process, a chemical etching process, or other alternative methods. When forming the pattern 113 by laser etching or chemical etching, process parameters are maintained that result in a surface roughness of about 300 nm-400 nm for the pattern 113 can be achieved.

In the case of a laser etching process, a fiber optic laser may be used. The laser etching process may be carried out under the following parameters: an etching power of about 4 W-6 W, a scanning rate of about 800 mm/s-1200 mm/s, an etching interval no larger than 0.02 mm, and an etching depth of about 0.02 mm-0.03 mm.

In the case of a chemical etching process, an etching solution containing about 100 g/L-150 g/L ferric chloride may be used. The etching solution has a specific gravity of about 1.2-1.6, and the etching solution contains hydrogen ions at a concentration of about 0.3 mol/L-0.6 mol/L. During the chemical etching process, the etching solution may be maintained at a temperature of about 45° C.-60° C. The etching rate may be about 0.03 mm/min-0.07mm/min. The etching depth may be controlled at about 0.08 mm-0.10 mm.

The substrate 11 is then treated by an electrolyte-plasma polishing process. During the electrolyte-plasma polishing process, the substrate 11 is immersed in an electrolyte accommodated stainless steel container (not shown), with the substrate 11 as an anode and the stainless steel container as a cathode. A direct-current voltage of about 280 V-380 V is applied between the anode and the cathode for about 80 seconds (s) to about 150 s. The electrolyte is maintained at a temperature of about 90° C.-98° C. during the process. The electrolyte is an aqueous solution containing about 3 wt %-5 wt % ammonium sulfate or potassium sulfate, and about 0.5 wt %-1 wt % ammonium citrate or ethanedioic acid. The process may be repeated about 3-7 times. The pattern 113 achieves a surface roughness of about 50 nm-150 nm.

The pattern 113 is covered with an ink layer. The ink layer will protect the pattern 113 from damages during the subsequently process of sandblasting or hairline finishing the non-pattern area 115. The ink for the ink layer may be a thermosetting ink or UV curable ink. The ink layer may be flush with the non-pattern area 115.

The substrate 11 may be processed by sandblasting or hairline finishing, thereby a sandblasted surface or a hairline finished surface is formed on the non-pattern area 115.

The ink layer is removed by using a chemical dissolving solution, such as an aqueous solution containing about 5 wt % sodium hydroxide. The chemical solution does not effect to the substrate 11 while dissolving the ink layer.

It should be understood, the step of sandblasting or hairline finishing the substrate 11 to achieve a sandblasted surface or a hairline finished surface and relative steps may be omitted.

### EXAMPLES

Experimental examples of the present disclosure are described as follows.

### Example 1

A sample of SUS303 substrate is cleaned with alcohol in an ultrasonic cleaner for about 10 minutes.

A pattern area is formed on the outer surface of the substrate by laser etching. The laser etching process is carried out under the following parameters: an etching power of about 5 W, a scanning rate of about 1000 mm/s, an etching interval of about 0.02 mm, and an etching depth of about 0.03 mm.

The substrate is then treated by an electrolyte-plasma polishing process. The substrate is immersed in an electrolyte accommodated stainless steel container, with the substrate as an anode and the container as a cathode. A direct-current voltage of about 300 V is applied between the anode and the cathode for about 120 s. The electrolyte is maintained at a temperature of about 95° C. during the process. The electrolyte is an aqueous solution containing 5 wt % ammonium sulfate and 0.5 wt % ammonium citrate. The process is repeated about 5 times.

The pattern area is covered with a UV curable ink layer. Then, the substrate is processed by hairline finishing. The UV curable ink layer is dissolved by an aqueous solution containing about 5 wt % sodium hydroxide.

### Example 2

A sample of SUS304 substrate is cleaned with alcohol in an ultrasonic cleaner for about 10 minutes.

A pattern area is formed on the outer surface of the substrate by laser etching. The laser etching process is carried out under the following parameters: an etching power of about 5 W, a scanning rate of about 1000 mm/s, an etching interval of about 0.02 mm, and an etching depth of about 0.03 mm.

The substrate is then treated by an electrolyte-plasma polishing process. The substrate is immersed in an electrolyte accommodated stainless steel container, with the substrate as an anode and the container as a cathode. A direct-current voltage of about 320 V is applied between the anode and the cathode for about 100 s. The electrolyte is maintained at a temperature of about 95° C. during the process. The electrolyte is an aqueous solution containing 5 wt % potassium sulfate and 0.8 wt % ethanedioic acid. The process was repeated for about 5 times.

The pattern area is covered with a UV curable ink layer. Then, the substrate is process by hairline finishing. The UV curable ink layer is dissolved by an aqueous solution containing about 5 wt % sodium hydroxide.

### Example 3

A sample of SUS304 substrate is cleaned with alcohol in an ultrasonic cleaner for about 10 minutes.

A pattern area is formed on the outer surface of the substrate by chemical etching. An etching solution containing about 120 g/L ferric chloride was used. The etching solution has a specific gravity of about 1.4, and the etching solution contained hydrogen ions at a concentration of about 0.5 mol/L. During the chemical etching process, the etching solution is maintained at a temperature of about 50° C. The etching rate is about 0.05 mm/min The etching depth is controlled at about 0.08 mm.

The substrate is then treated by an electrolyte-plasma polishing process. The substrate is immersed in an electrolyte accommodated stainless steel container, with the substrate as an anode and the container as a cathode. A direct-current voltage of about 380 V is applied between the anode and the cathode for about 130 s. The electrolyte is maintained at a temperature of about 95° C. during the process. The electrolyte is an aqueous solution containing 5 wt % ammonium sulfate and 0.5 wt % ammonium citrate. The process is repeated for about 6 times.

The pattern area is covered with a UV curable ink layer. Then, the substrate was process by hairline finishing. The UV curable ink layer is dissolved by an aqueous solution containing about 5 wt % sodium hydroxide.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A stainless steel article, comprising:
a stainless steel substrate, the substrate having an outer surface; and
a pattern formed on the substrate, the pattern being defined by at least one recess formed on the outer surface, the pattern having a surface roughness of about 50 nm-150 nm.

2. The stainless steel article as claimed in claim 1, the stainless steel article further comprising non-pattern areas, the non-pattern areas being portions of the outer surface besides the pattern.

3. The stainless steel article as claimed in claim 2, wherein the non-pattern areas have a sandblasted surface.

4. The stainless steel article as claimed in claim 2, wherein the non-pattern areas have a hairline finished surface.

5. The stainless steel article as claimed in claim 1, wherein the depth of the at least one recess is about 0.08 mm-0.10 mm.

6. A method for making a stainless steel article, comprising the steps of:
providing a stainless steel substrate, the substrate having an outer surface;
forming a pattern on the outer surface by laser etching or chemical etching, the pattern defined by al least one recess, the pattern having a surface roughness of about 300 nm-400 nm;
electrolyte-plasma polishing the substrate, thereby the pattern achieving a surface roughness of about 50 nm-150 nm.

7. The method as claimed in claim 6, wherein the laser etching process is carried out under the following parameters: an etching power of about 4 W-6 W, a scanning rate of about 800 mm/s-1200 mm/s, an etching interval no larger than 0.02 mm, and an etching depth of about 0.02 mm-0.03 mm.

8. The method as claimed in claim 6, wherein during the chemical etching process, an etching solution containing about 100 g/L-150 g/L ferric chloride is used; and the etching solution contains hydrogen ions at a concentration of about 0.3 mol/L-0.6 mol/L; the etching solution is maintained at a temperature of about 45° C.-60° C.

9. The method as claimed in claim 8, wherein the chemical etching process has an etching rate of about 0.03 mm/min-0.07 mm/min.

10. The method as claimed in claim 8, wherein the etching solution has a specific gravity of about 1.2-1.6.

11. The method as claimed in claim 6, wherein during the electrolyte-plasma polishing process, the substrate is immersed in an electrolyte accommodated in a stainless steel container, with the substrate as an anode and the stainless steel container as a cathode; a direct-current voltage of about 280 V-380 V is applied between the anode and the cathode for about 80 s-150 s; the electrolyte is maintained at a temperature of about 90° C.-98° C. during the process.

12. The method as claimed in claim 11, wherein the electrolyte is an aqueous solution containing 3 wt %-5 wt % ammonium sulfate or potassium sulfate, 0.5 wt %-1 wt % ammonium citrate or ethanedioic acid.

13. The method as claimed in claim 11, wherein the electrolyte-plasma polishing process is repeated about 3-7 times.

14. The method as claimed in claim 8, further comprising the steps of:
covering the pattern with an ink layer;
sandblasting or hairline finishing the substrate to achieve a sandblasted surface or a hairline finished surface on the other portion of the outer surface besides the pattern; and
removing the ink layer.

15. The method as claimed in claim 14, wherein the ink used for the ink layer is thermosetting ink or UV curable ink.

16. The method as claimed in claim 14, wherein the ink layer is removed by using a chemical dissolving solution.

17. The method as claimed in claim 16, wherein the chemical solution is an aqueous solution containing about 5 wt % sodium hydroxide.
